(19) United States
(12) Patent Application Publication
(10) Pub. No.: US 2004/0049405 A1
(43) Pub. Date: Mar. 11, 2004

(54) Management system for the provision of services

(76) Inventors: Christof Buerger, Erlangen (DE); Frank Elssner, Lauf (DE); Peter Poos, Burgthann (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/637,688

(22) Filed: Aug. 11, 2003

Related U.S. Application Data
(63) Continuation of application No. PCT/DE02/00503, filed on Feb. 12, 2002.

(30) Foreign Application Priority Data
Feb. 12, 2001 (DE) 101 06 325.3

(51) Int. Cl. G06F 17/60; G06F 11/30; H04Q 7/20; H04B 1/74; G06F 9/44

(52) U.S. Cl. 705/1; 717/172; 714/27; 455/41.2; 455/66.1; 455/466

(57) ABSTRACT

The invention relates to a management system for the provision of services, comprising telecommunication means enabling data to be exchanged between communication terminals associated with a master terminal and service providers, wherein the master terminal can transmit data, which enables a service provider to perform a service corresponding to an actual request, to the communication terminal of an available service provider.

### BACKGROUND OF THE INVENTION

The present invention relates to a management system for the performance of services. In the present system, a master terminal allocates the implementation of incoming service requests to service providers assigned to the master terminal.

A management system for providing technical customer support services is known wherein the system includes a master terminal as a customer service master terminal and customer service engineers as service providers. The customer service engineers carry laptop computers and mobile telephones with them. A database is stored on the laptop. The database contains data which the engineers will need for all possible deployment sites. The data further relates to performing a task requested by the customer to the engineer. As soon as a customer service engineer has performed a customer service which may, for example, include the maintenance, repair, upgrading or checking of a device, in particular of a medical-engineering device, he/she uses the mobile telephone to report his/her availability to the customer-service master terminal, which then informs him/her of his/her next deployment site. The customer service engineer then obtains from the database, stored on the laptop, the data necessary to perform the customer service to be provided at this deployment site.

It is considered disadvantageous in the above management system that the customer service engineer carries the data he/she needs with him/her in the form of a comprehensive database. Basis for this disadvantage include data security concerns as well as the risk that the carried data may not be the most current or up-to-date data available. Accordingly, speedy and effective handling of the maintenance could be impaired.

### SUMMARY OF THE INVENTION

An object of the present invention is to specify a management system for the performance of services which takes principles of data security into account and enables the speedy and successful performance of services.

This object may be achieved by the present invention wherein the master terminal uses telecommunication means to supply a service provider, available for the service concerned, with precisely the data he/she needs in order to perform the service at hand. Accordingly, this ensures that the service provider carries with him/her only the data which is absolutely necessary for the job at hand. It rules out the possibility of providing service with inadequate data, since the master terminal transmits to him/her the most up-to-date data available in each case.

A feature of the invention lay in that the data enabling performance of a service corresponding to the respective service request is transmitted to the service provider in accordance with the push principle, i.e. as soon as the master terminal determines that a service provider is available and that a service request has been made which is suitable for this service provider, the service provider receives the corresponding data without having to do anything himself.

An embodiment of the present invention provides that the communication terminal is designed such that status data regarding the performance status of the service concerned can be input and that with regard to the service concerned such status data can be transmitted to the master terminal.

In a feature of the invention, the communication terminals are designed for inputting status or availability data relating to the future availability of the service provider. The status data is transmitted from the communication terminal to the master terminal. The master terminal includes means for receiving and storing the availability data as data relating to the availability of a particular service provider. This ensures that the master terminal always has up-to-date data relating to the availability of service providers.

It is another feature of the present invention that wireless telecommunication means are provided, via which data is exchanged using SMS (short message service).

A computer operating together with the telecommunication means form at least the means for storing data relating to incoming service requests and/or the means for receiving and storing data concerning the availability of service providers.

The communication terminals may comprise personal digital assistants (PDAS) equipped with mobile communication modules, modems and the like. Use of PDAs are a well known, easy and handy method of communicating information. The PDAS may further be equipped with scanning means for scanning in spare parts numbers and the like, themselves represented as bar codes. The scanned in data can then be easily transmitted to the master terminal and the like.

The management system according to the invention is suitable for handling any services, but especially for handling customer technical support services and for handling nursing services in the medical field. The service providers concerned would then be nursing personnel and the master terminal a nursing service center.

The present invention comprises a services performance management system, comprising: a master terminal comprising means for receiving incoming service requests, means for storing request data relating to said incoming requests, said request data comprising enabling data which enables a service provider to perform a service corresponding to said service requests, and means for receiving and storing availability data regarding availability of service providers assigned to said master terminal, a plurality of mobile communication terminals functionally associated with said master terminal, each one of said terminals assigned to one of said service providers, and telecommunication means for facilitating exchange of data between said master terminal and said communication terminals, said telecommunication means functionally associated with said master terminal and said communication terminals, said exchange of data comprising a transmission from said master terminal to a communication terminal regarding available service provider, said transmission enabling a service provider to perform a service corresponding to a service request.

### BRIEF DESCRIPTION OF THE SEVERAL VIEWS OF THE DRAWINGS

The novel features believed characteristic of the invention are set out in the claims below. The invention itself, however, as well as other features and advantages thereof, are best understood by reference to the detailed description, which follows, when read in conjunction with the accompanying drawings, wherein:

FIG. 1 depicts a flow chart illustrating the handling of an incoming customer service request,

FIG. 2 depicts a representation of the data exchange between the mobile telecommunication terminal of a service provider and the master terminal computer,

FIG. 3 depicts the telecommunication means provided for handling the exchange of data between the master terminal computer and the telecommunication terminals of the service providers controlled by this master terminal, and

FIGS. 5 to 11 depict diagrams illustrating the process steps operating when an incoming customer service request is handled.

### DETAILED DESCRIPTION OF THE INVENTION

The present invention is described hereinbelow based on the example of a management system which is used for handling customer service requests which are received, for example after the occurrence of a malfunction in a medical installation supporting a remote diagnosis (e.g. a CT device), in a master terminal, namely a user service center (USC). The master terminal serves to control service providers, namely customer service engineers (CSEs). The present invention may be applied to other situations as envisioned by one skilled in the art. To aid understanding, the handling of an incoming customer service request by a state-of-the-art management system is reiterated here:

The USC records the malfunction when the customer calls,

The USC then calls a CSE who has reported his/her (imminent) availability to the USC,

The CSE takes on the request,

The CSE notes the deployment data,

When the deployment starts, possibly after completion of a deployment still ongoing when the USC called, the CSE calls the USC in order to report the start of the deployment, and makes his/her way to the deployment site,

Dispatch in the USC makes a corresponding entry stating that the assigned CSE is now busy,

After arrival at the deployment site, the CSE once again calls the USC in order to report his/her arrival at the deployment site,

Dispatch in the USC also records this data,

Upon completion of the deployment, the CSE calls the USC again and reports the completion of the deployment, and

Dispatch records the customer service as completed and makes a further entry, indicating that the CSE concerned is available again.

Clearly, a large number of telephone calls are required. It is for this reason that the CSEs are equipped with mobile telephones. Likewise, entries have to be made in parallel with each telephone call in order for the handling of the customer service to be organized effectively.

With regard to the data relating to the installation concerned, the CSE at the deployment site has to depend on a database which is stored on a laptop. The database is decentralized and therefore the data therein is never fully up-to-date. The CSE must also draw up reports on paper, including a work report in the form of a service report (SR).

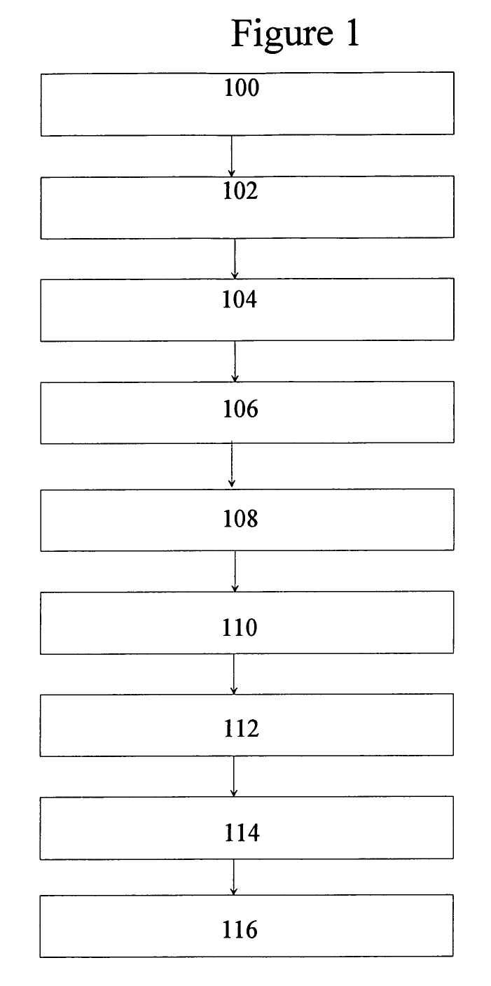

With reference to FIG. 1, in the management system according to the invention, by contrast, an incoming customer service request is handled using SMS rather than telephone calls as a communication channel between USC and CSE, and includes the following:

Recording of malfunction by the USC (100),

Preliminary clarification of malfunction by the USC (102),

Assignment of a CSE to the malfunction via SMS, SMS initiates collection of deployment data and malfunction history by the CSE (104),

CSE informs USC via SMS of anticipated arrival at client site (106),

CSE informs USC via SMS of actual commencement of deployment (108),

CSE informs USC via SMS of his/her arrival at the customer site (110),

Performance of customer service by the CSE (112),

CSE informs USC via SMS of completion of the deployment and sends his/her service report (114), and

Entry made indicating customer service completed and a further entry made indicating that the respective CSE is available again (116).

When the data mentioned is sent, corresponding entries are made automatically in business management software (e.g. SAP).

Accordingly, telephone calls are unnecessary, the CSE is sent up-to-date data about the installation concerned, thereby avoiding the need for a distributed database, and reporting on paper is dispensed with.

In order to be able to exchange the above-mentioned SMSs with the USC, the CSEs are equipped not with mobile phones but with communication terminals in the form of PDAs with mobile radio communication modems. The PDAs may further be furnished with a scanner for recording data, for example spare parts numbers in the form of bar codes. The scanned in data is then to be transmitted to the master terminal via the PDA.

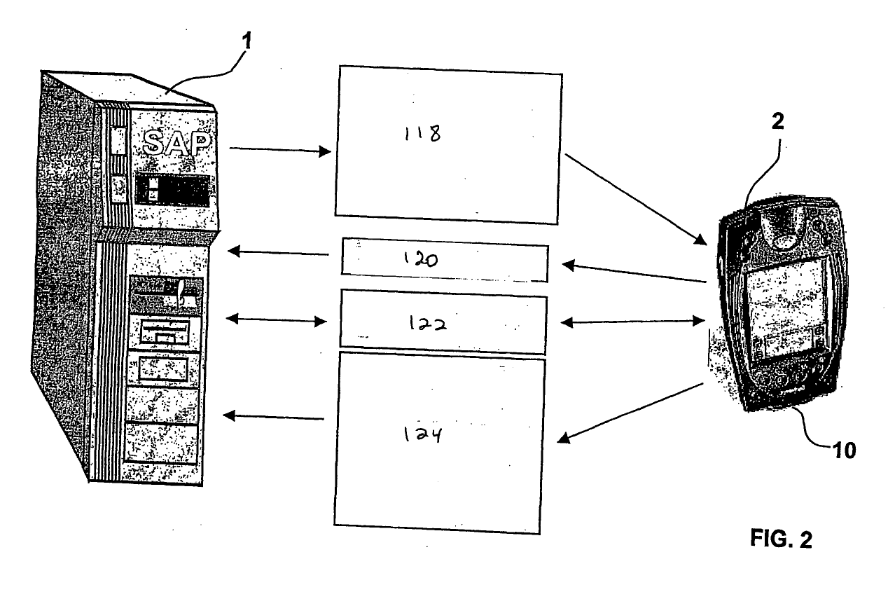

The handling of a customer service is based on an exchange of data, more precisely an exchange of SMSs, between the computer 1 of the USC and the PDA 2 of the particular CSE deployed to provide the customer service. Here, the data is processed on the computer 1 of the USC, preferably with the aid of business management software such as SAP, for example. The scanner of the PDA 2 is numbered 10 in FIG. 2.

As may also be seen from FIG. 2, the exchange of data, which takes the form of an exchange of SMS, between the computer 1 of the USC and the PDA 2 of the CSE, can be subdivided into the following four groups.

In the first group (118), the following is transmitted to the CSE:

the general assignment data,

the malfunction history of the plant concerned,

the preliminary clarification result obtained from the USC,

the contractual status of the customer receiving support, i.e. whether a service agreement exists with this customer,

the contractual terms, e.g. flat-rate payment, or whether customer services provided for the customer are to be charged for,

the specific installation configuration which is present at the customer site, and

any spare parts already pre-ordered by the USC on the basis of the results of the preliminary clarification.

In a second group (120), the CSE uses his/her PDA 2 to transmit to the USC:

data relating to various times required for the handling of the customer service, and

so-called time stamps, which enable the USC to record, plan and monitor the time sequence of the customer service.

In a third group (122), data is exchanged bi-directionally between the USC and the CSE in relation to the spare parts inquiry, i.e. the inquiry as to whether certain spare parts are available, and the spare parts order.

In a fourth group (124), data is transmitted by the CSE to the USC, and here it is preferably a question of data to be transmitted after the deployment has been completed, such as general deployment data, spare parts usage data, data relating to the tracking of spare parts, i.e. data relating to the route of spare parts to the CSE, data relating to charges incurred, data relevant to the quality system and the CSE's service report (SR).

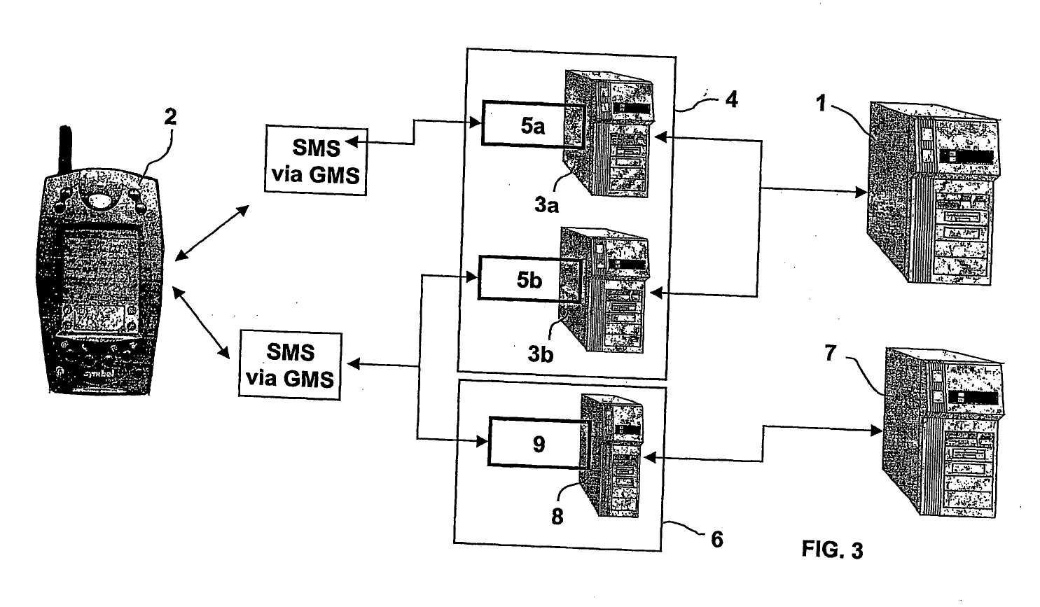

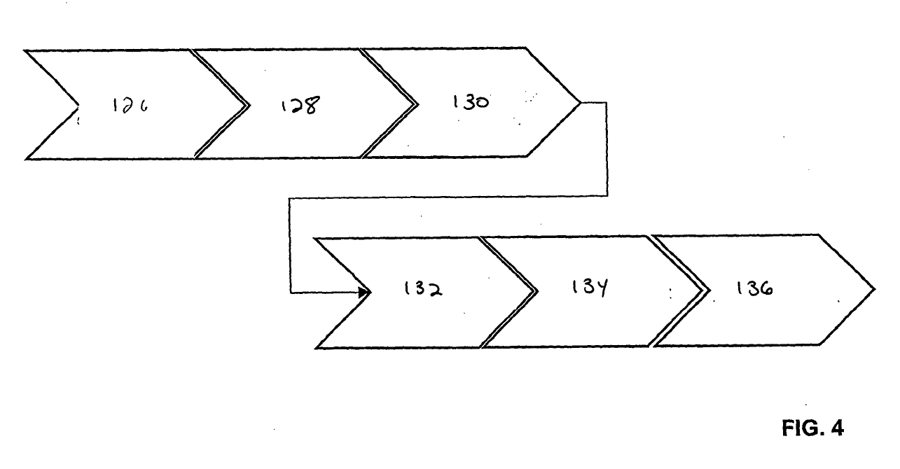

FIG. 3 depicts the telecommunication means which enables the exchange of data between the USC and the CSEs controlled by said USC.

Accordingly, the USC has a computer 1 which works together with two parallel computers 3a and 3b of a productive system 4. The computers 3a and 3b each have an ISDN controller, 5a and 5b respectively, each of which has 30 lines.

The productive system 4 allows the computer 1 of the USC to communicate, by means of SMSs which are transmitted using the GSM standard, for example, with the PDAs 2 of the CSEs. Again, for the sake of clarity, only a single PDA 2 is shown in FIG. 3.

The productive system 4 has two computers 3a, 3b in order for it to be able to continue to operate the management system at least over half the bandwidth in the event of failure of one of the two computers 3a, 3b.

The computers 3a, 3b of the management system 4 serve only to handle the SMS traffic between the PDAs 2 of the CSEs and the computer 1 of the USC. The actual management of the system is carried out with the aid of the computer 1 of the USC on which computer all relevant data as well as the business management software is located.

In parallel to the productive system 4 and the computer 1 of the USC, a testing and development system 6, as shown in FIG. 3, may be provided. The system having a computer 7 which in the testing and development system 6 assumes the role of the computer 1 of the USC and works together with a computer 8 with ISDN controller 9, the computer 1 assuming in the testing and development system 6 the function of one of the computers 3a and 3b of the productive system 4.

The process flow in the handling of a customer request service is again explained in detail below with reference to FIGS. 4 to 11.

According to FIG. 4, the process flow is subdivided into six blocks, namely the “Process trigger” (126), i.e. the request for the customer service, and blocks designated “Support” (128), “Dispatch” (130), “CSE deployment” (132), “Feedback” (134) and “Flow of values” (136), wherein the “Flow of values” essentially deals with the business management recording of the relevant data arising in connection with the provision of the customer service.

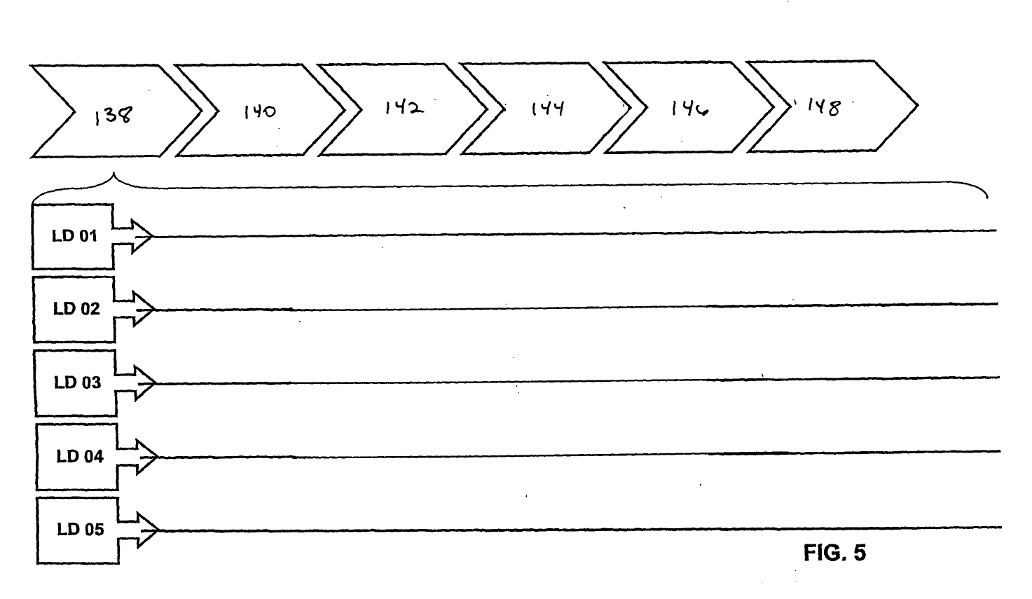

This process sequence, subdivided into six blocks, is again shown in each of FIGS. 5 to 11, and one of the blocks is illustrated in greater detail, and where appropriate, in the form of sub-blocks.

FIG. 5, includes the “Process trigger” block (126). Accordingly, one of, for example, five positions LD01 to LD05 in the USC, which are provided for handling messages from customers about problems and/or faults and/or service requests, accepts the incoming customer service request and compiles a corresponding message (138). This message is forwarded to the “Support” (140) and “Dispatch” (142) blocks. In addition, an assessment of the anticipated repair value can be made if specified by the customer.

This data which is recorded by one of positions LD01 to LD05 is passed, as mentioned, to the “Support” block.

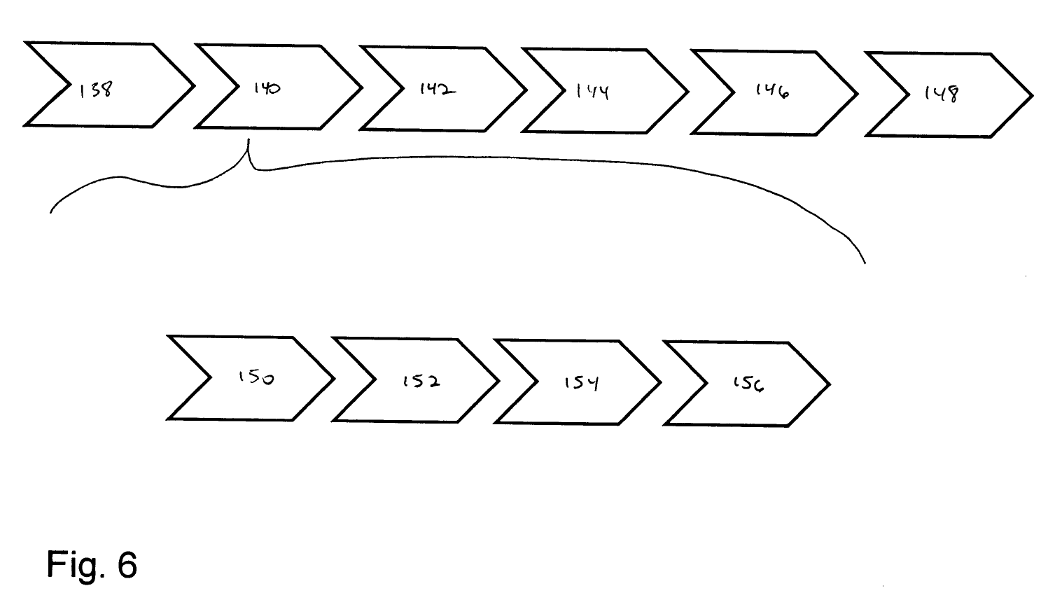

This block (140) is subdivided as per FIG. 6 into four sub-blocks, namely “Preliminary clarification with the customer” (150), “Remote diagnosis” (152) and, where necessary, “Spare parts proposal” (154) and “Forwarding to Dispatch” (156).

The “Preliminary clarification with the customer” (150) sub-block comprises a return call to the customer in order to localize the present fault which is the cause of the present malfunction. The return call is made in accordance with defined rules, e.g. based on a list of questions.

If this fails, in the case of the embodiment described, a remote diagnosis is carried out on the malfunctioning device in the process of the “Remote diagnosis” (152) sub-block. The support engineer does this by logging into the customer's system, i.e. he/she establishes contact with the malfunctioning equipment by means of remote data transmission, downloads the error logs and evaluates them.

Next, a provisional order for any spare parts required is created in the process of the sub-block “Spare parts proposal” (154). Irrespective of whether the malfunction is clarified during the “Preliminary clarification with the customer” (150) sub-block or not until the “Remote diagnosis” (152) sub-block, and irrespective of whether spare parts are needed or not, an evaluation will also be made of the duration of the deployment, at the latest in the process of the “Spare parts proposal” (154) sub-block.

The data accumulated in the process of the “Preliminary clarification with the customer” (150), “Remote diagnosis” (152) and “Spare parts proposal” (154) sub-blocks is forwarded to the “Dispatch” block (142), as is a preferred time, requested by customers in the process of preliminary clarification, for performance of the customer service. Should preliminary clarification not have been possible during the “Support” (140) block and should clarification be possible only by the CSE on site, the case will also be forwarded, with the preferred time, to “Dispatch” (142).

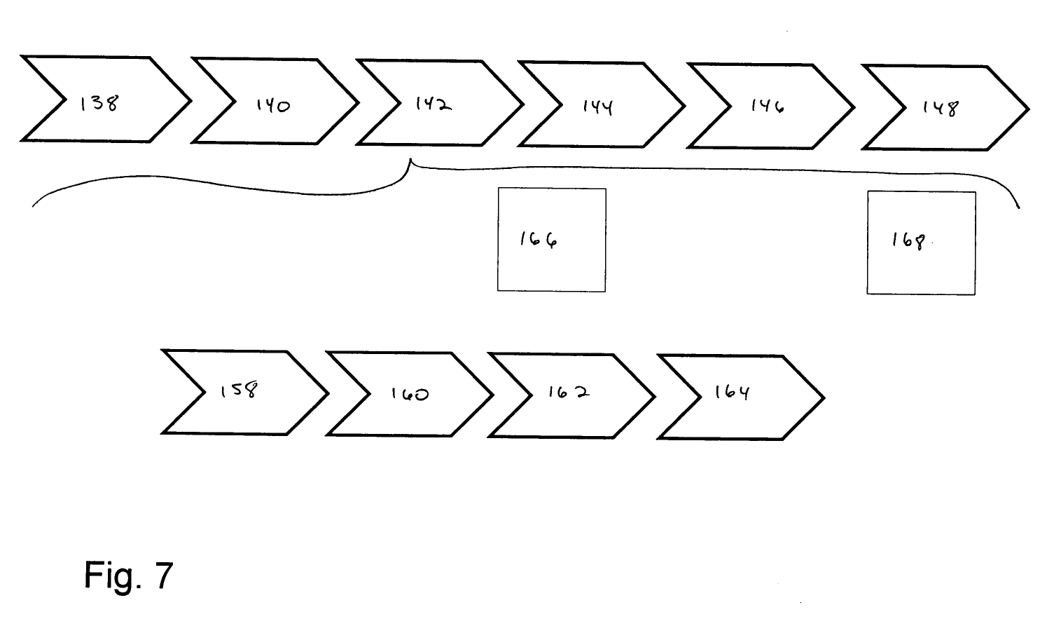

The “Dispatch” (142) block is illustrated in greater detail in FIG. 7 and, as shown there, comprises the “Complete spare parts order” (158), “CSE status” (160), “Release dispatch” (162) and “Customer information” (164) sub-blocks.

In the process of the “Complete spare parts order” (158) sub-block, firstly, a CSE who is available for the customer service request concerned is timetabled in by “Dispatch” (142) using the data present in the USC about available CSEs. Depending on the deployment site and the CSE timetabled in, a drop-off point (DOP) is then specified for any spare parts needed. The spare parts order received from “Support” (140) has the DOP added and is dispatched.

In the “Set CSE status” (160) sub-block, the CSE timetabled in to perform the customer service concerned is entered against this procedure and, for the duration of the deployment, the CSE is set from free to busy in the data relating to the availability of CSEs. During the “Dispatch released” (162) sub-block, the selected CSE is then released for the customer service concerned, as a consequence of which an SMS, shown (and as mentioned above) as a sheet of paper and labeled CAD (Collect assignment data) (166) is sent by USC to the PDA of the CSE concerned. This prompts the CSE to request at the next opportunity an SMS containing the assignment data for a new assignment. This SMS is labeled ADP (assignment data package) (168) in FIG. 7 and is sent by USC, when requested by the responsible CSE to the CSE's PDA. Alternatively, provision can be made for the CSE responsible to receive the ADP SMS automatically.

In addition, a return call is made to the customer by the USC in the process of “Dispatch” (142) in the “Customer information” (164) sub-block, so as to inform the customer of the actual date for performance of the customer service.

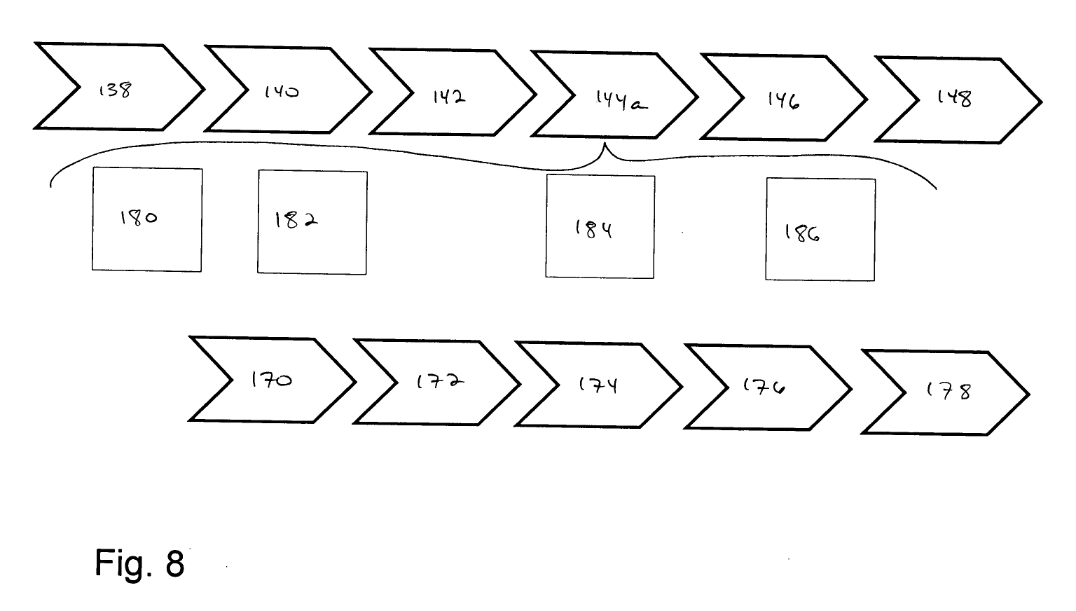

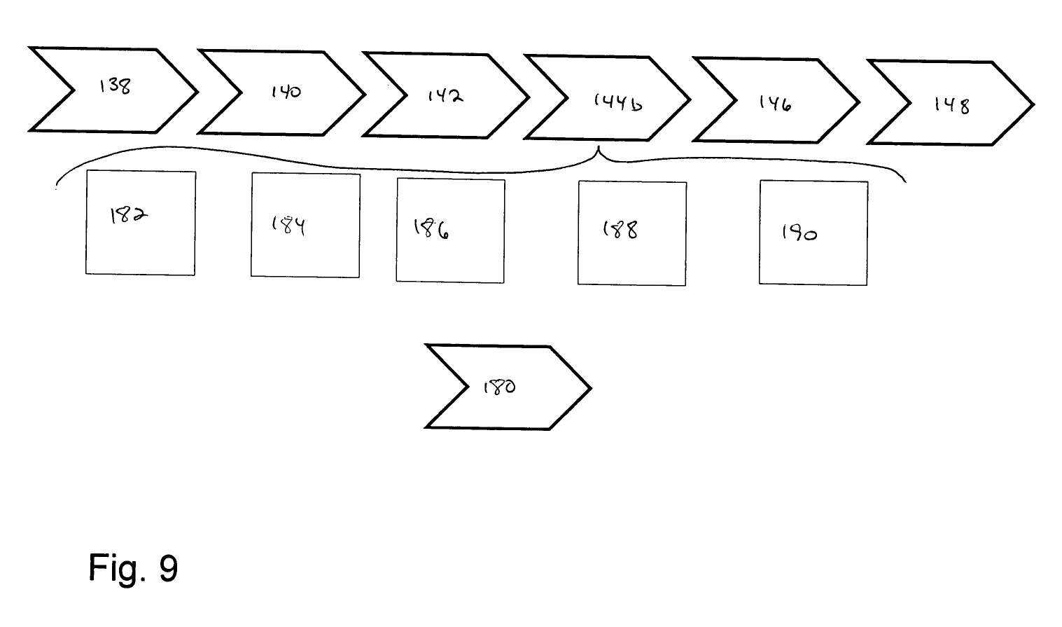

Due to their complexity, the procedures under “CSE deployment” (144a and 144b) are shown in two Figures, namely FIGS. 8 and 9. The procedures shown in FIG. 8 being designated “CSE deployment I” (144a) and the procedures shown in FIG. 9 being designated “CSE deployment II” (144b).

The sub-blocks associated with “CSE deployment I” (144a) are, as shown in FIG. 8, “ETA measure+time stamp” (170), “FZB measure+time stamp” (172), “CSE collects materials” (174), “OSR measure+time stamp” (176) and “Service” (178).

In the process of the “ETA measure+time stamp” (170) sub-block, the CSE confirms acceptance of the assignment data package ADP and makes known his/her estimated time of arrival (ETA, 180) at the deployment site by sending a corresponding SMS, labeled (TTS, 182) in FIG. 8, via his/her PDA to the USC, the SMS containing a time stamp relating to the estimated time of arrival.

As soon as the CSE (144a and 144b) sets off for the deployment site, he/she sends, in the process of the “TTS measure+time stamp” (172) sub-block, a further SMS, labeled TTS (Travel time start, 182) in FIG. 8, to the USC. The SMS containing a further time stamp indicates the travel time start, i.e. the departure time of the CSE.

Where the particular deployment requires this, the CSE travels to the deployment site, in the process of the “CSE fetches materials” sub-block (174), via a DOP in order to pick up from the DOP any materials needed, e.g. spare parts, which have in the meantime been deposited there at the behest of Dispatch. The CSE confirms the pick-up of the materials by sending an SMS, labeled PMD (pick up materials from drop-off point, 184) in FIG. 8 and containing a corresponding time stamp, to the USC.

When the CSE arrives at the deployment site, the CSE sends in the process of the “OSR (On-site repair) measure+time stamp” sub-block (176) an SMS, labeled (186) in FIG. 8, to the USC, said SMS containing the time stamp confirming the arrival of the CSE at the deployment site.

It is thus clear that the USC is kept constantly informed of the processing and progress of the customer service through the various time stamps sent in the process of “CSE deployment I” (144a).

After arriving at the deployment site, the CSE begins, in the process of the “Service” (178) sub-block, actual performance of the customer service and, 30 minutes before the end of the deployment period timetabled by Dispatch, is reminded by his/her PDA by means of an appropriate, for example acoustic, signal to report to the USC in order to inform the USC whether the customer service can be completed within the timetabled deployment period or whether additional time will be needed.

The subject matter of “CSE deployment II” (144b) is, as shown in FIG. 9, a single sub-block, namely “MOR measure+time stamp”, which concerns those procedures which will run in the event of the CSE needing, in order to provide the customer service, materials or spare parts which he/she has not already collected at the DOP on his/her way to the deployment site. These procedures can take place at any time during the deployment.

If the CSE establishes that he/she will need materials, e.g. a spare part, then he/she sends an appropriate SMS, labeled (182) MAR (materials availability request) in FIG. 9, to the USC and receives feedback, also in the form of an SMS, labeled (184) MAF (materials availability feedback) in FIG. 9, as to whether and when the materials required are available.

The CSE is then in a position to order the materials by means of an SMS, labeled (186) MOR (materials order report) in FIG. 9. The MOR SMS goes to the USC, accompanied by a time stamp concerning the time of the order (180). In a further SMS, labeled (188) MAF (materials availability feedback) in FIG. 9, the CSE is informed that the order has arrived in the USC. Further information, for example about when and at which DOP the ordered materials will be available, is communicated by the USC to the CSE in an SMS, labeled (190) OFB (Order feedback) in FIG. 9. If the materials arrive at the DOP at a time at which an interruption in the customer service would appear appropriate, the necessary measures are taken by Dispatch.

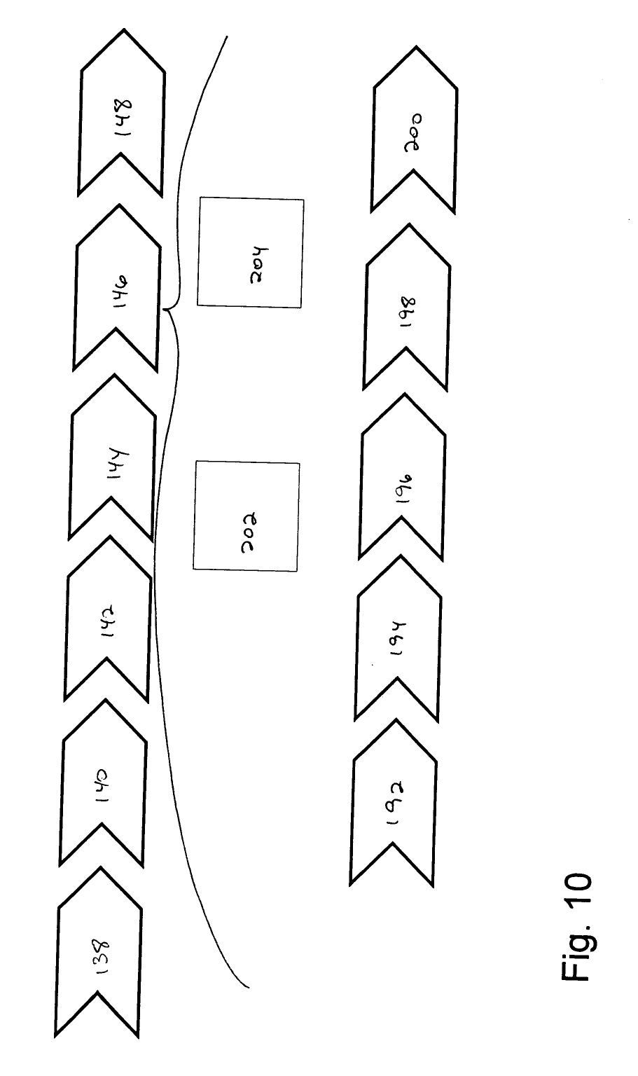

The “Feedback” block (146) which follows the customer service performed in the process of the “CSE deployment” (144) block is illustrated in greater detail in FIG. 10. As shown there, it is divided into the sub-blocks “Recording of equipment” (192), “Materials, time and fault report” (194), “Follow-up activity yes/no” (196), “Materials return” (198) and “Wait for next assignment” (200).

In the process of the “Recording of equipment” sub-block (192), the CSE selects the installation equipment affected by the malfunction (components, parts or even software). This can for example be done using the display of a hierarchical representation, stored in the PDA, of the equipment belonging to the installation concerned.

In the “Materials, time and fault report” sub-block (194), the CSE uses the PDA to record the materials, e.g. spare parts, and time which were necessary in order to perform the customer service and draws up an SR. These activities are supported by standard texts stored in the PDA.

After the CSE has decided in the process of the “Follow-up activity yes/no” sub-block (196) whether the customer service is to be viewed as completed or whether follow-up activities are necessary, he/she sends an SMS, labeled (202) (CSE feedback) in FIG. 10, to the USC. The SMS contains the data accumulated in the process of the three sub-blocks explained earlier, including the text of the SR.

In the process of the “Materials return” sub-block (198), the CSE deposits at a DOP any materials to be returned to the head office, for example unneeded consumables, materials to be allocated for recycling or reconditioning processes or defective parts, and sends an SMS, labeled (204) MDA (Deposit material at DOP) in FIG. 10, to the USC, informing the USC of the deposit that has been made at the DOP. The CSE then stands by for the next assignment, which is illustrated by the “Wait for next assignment” sub-block (200).

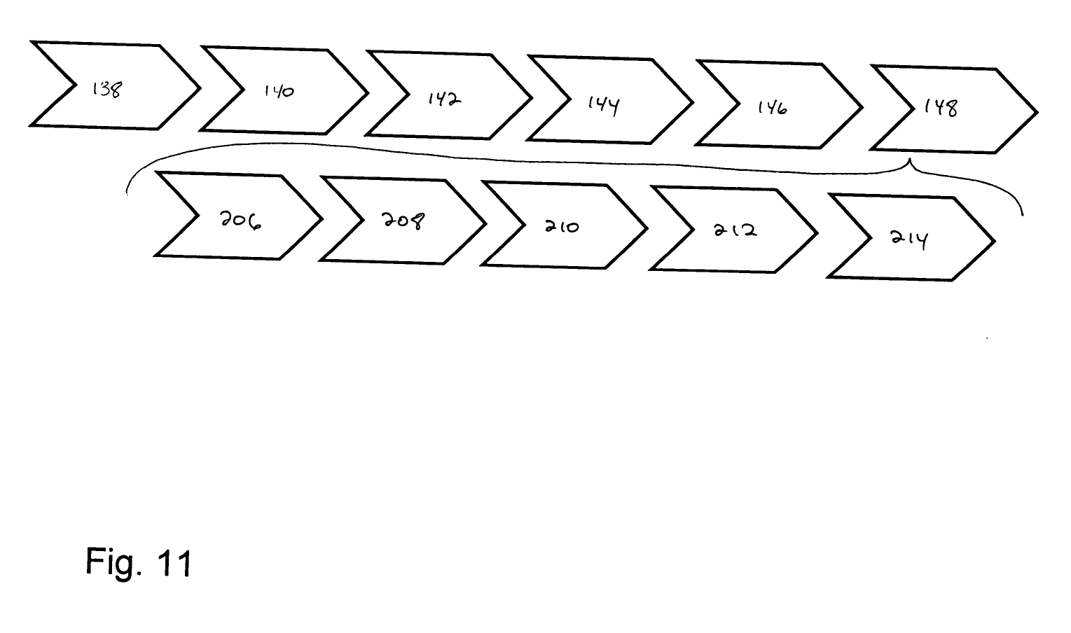

The remaining “Flow of values” block (148) is subdivided as per FIG. 11 into the sub-blocks “Derivation of AC” (206), “Derivation of MC” (208), “Traveling expenses” (210), “Processing as per control tables” (212) and “Derivation of further variables” (214).

These blocks are processed by the business management software located on the USC's computer 1, on the basis of SMSs received from the CSE.

In the process of the “Derivation of AC” sub-block (206), an activity code (AC) is determined, taking into account any existing customer service agreements. A materials code (MC) is derived, likewise taking into account the terms of any customer service contract, in the “Derivation of MC” sub-block (208).

The costs which have been incurred as a result of the CSE traveling to the deployment site are determined in the process of the “Traveling expenses” sub-block (210). This can be done as a flat rate or based on the journey time or the number of kilometers.

The data acquired in the three explanatory sub-blocks is processed further in the “Processing” sub-block (212) in accordance with control tables filed in by the business management software. Depending on the contractual situation, this may for example lead to the costs being billed to the customer or to their being accounted for internally.

In the “Derivation of further variables” block (214), the data is, for example, evaluated according to quality criteria, e.g. in order to be able to identify equipment which frequently gives rise to customer service requests.

In conclusion, it may be stated that:

The CSE receives all data necessary for the current assignment such as the history, contractual status, results of the preliminary clarification and malfunction report.

It is possible for Dispatch to use a global template of the business management software used (e.g. SAP), whereby the date is automatically entered into the global template in order to determine technical performance figures.

A considerable simplification of the workflow is achieved since it is no longer necessary to send the SR after the work has been completed.

The task of drawing up the SR and any returned goods note is simplified. It is done electronically (no printer required) and involves a minimum amount of writing.

The recording of the base data for ARs is carried out in the field, i.e. at the deployment site. The AR is drawn up in the conventional way.

Dispatches are made according to the push principle.

This Enables:

replacement of the mobile phone as the standard means of communication for transmitting assignments,

replacement of the laptop, of the decentralized database stored on this laptop and of the printer by a compact mobile communication terminal with no database (e.g. PDA), as data is kept up to date and current only for the immediate assignment

extensive avoidance of written work through standard texts and the partial capture of data by scanner (e.g. of data relating to materials consumed and spare parts), and

reliable data transmission between communication terminal and master terminal via GSM, whereby in sensitive environments for mobile radio signals (e.g. in clinics) the communication terminal is operated offline in order to avoid malfunctions.

The type of communication terminals provided in the present embodiment include standard mobile radio communication devices.

The management system according to the invention is suitable for handling not just those customer services that are required as a result of malfunctions occurring, but for handling all customer services, irrespective of the reason for them, e.g. performance of a software update.

The management system according to the invention is also particularly suitable for handling customer services where medical care services, for example those provided by peripatetic nursing staff, are involved.

The following table of abbreviations is included for assisting the reader in following the several acronyms used throughout the specification. The abbreviations are described with the respect to the example embodiment. The descriptions are not intended to limit application of the present invention.

| Abbreviation | Keyword | Explanation |
|---|---|---|
| | CSE deployment | Procedures during |
| | | provision of the |
| | | service by the CSE |
| CSE | Customer service | Customer service |
| | engineer | engineer who is |
| | | sent by the USC to |
| | | perform services |
| | | waiting to be dealt |
| | | with at varying |
| | | deployment sites at |
| | | customer locations |
| | Dispatch | Assignment of |
| | | services to CSEs, |
| | | including planning |
| | | and/or deciding |
| | | which CSE is |
| | | deployed when/where |
| DOP | Drop-off point | For transport staff |
| | | and CSEs, a readily |
| | | accessible storage |
| | | point for materials |
| | | and/or spare parts |
| | | needed or returned |
| | | by CSEs; not |
| | | usually the same as |
| | | the deployment site |
| | Error log | Fault report stored |
| | | in an installation |
| | | or a device which |
| | | is the object of a |
| | | service, the fault |
| | | report being read |
| | | out at the Support |
| | | office during |
| | | remote diagnosis |
| | | using remote data |
| | | transmission |
| | Front end | CSE's communication |
| | | terminal |
| GSM | Global system for | Mobile radio |
| | mobile | communications |
| | communications | standard |
| | Mobile | Mobile telephone |
| | Laptop | Portable computer |
| LD01 to LD0n | | Offices which |
| | | receive messages |
| | | from customers |
| | | about problems |
| | | and/or malfunctions |
| | | and/or service |
| | | requests |
| | Materials | Materials needed in |
| | | order for a service |
| | | to be provided, |
| | | e.g. spare parts |
| MC | Materials code | Data relating to |
| | | the materials/spare |
| | | parts which have |
| | | been used in |
| | | performing a |
| | | service |
| | PALM | See PDA |
| PDA | Personal digital | Very compact |
| | assistant | computer which can |
| | | usually be held in |
| | | the hand and has a |
| | | small display and |
| | | inputting means; |
| | | since the device is |
| | | held in the palm of |
| | | the hand when being |
| | | used, it is also |
| | | frequently termed a |
| | | PALM. |
| | Process trigger | Customer service |
| | | request |
| | Push principle | The CSE receives |
| | | assignments from |
| | | the USC without |
| | | having to do |
| | | anything |
| | | himself/herself |
| | Quality system | Database in which |
| | | quality-related |
| | | data is recorded |
| | | and evaluated |
| | Remote diagnosis | Remote diagnosis of |
| | | a device or of an |
| | | installation |
| | | through the use of |
| | | remote data |
| | | transmission |
| | Resource | Available CSE |
| | Feedback | Procedures after |
| | | completion of the |
| | | service |
| SAP | Business management | |
| | software | |
| SR | Service report | Customer service |
| | | report |
| SMS | Short message | Message transmitted |
| | service | by mobile radio |
| | | communication |
| | Control table | Rules for posting |
| | | entries within the |
| | | business management |
| | | software |
| | Support | Office which |
| | | supports customers |
| | | in identifying |
| | | and/or eliminating |
| | | problems and/or |
| | | malfunctions |
| | System | Oblect of the |
| | | service, e.g. |
| | | device or |
| | | installation to be |
| | | maintained |
| AR | Activity record | List of activities |
| | performed when | |
| | | providing a service |
| AC | Activity code | Data relating to |
| | | the activities |
| | | performed when |
| | | providing a service |
| USC | User service center | Master terminal |
| | Contract status | Terms and |
| | | conditions of the |
| | | definitive customer |
| | | service agreement |
| | | in each case |
| | Global template | Universal mask in |
| | | business management |
| | software | |
| | Flow of values | Recording and entry |
| | | in business |
| | | management software |

1. A services performance management system, comprising:
a master terminal comprising
means for receiving incoming service requests,
means for storing request data relating to said incoming requests, said request data comprising enabling data which enables a service provider to perform a service corresponding to said service requests, and
means for receiving and storing availability data regarding availability of service providers assigned to said master terminal,
a plurality of mobile communication terminals functionally associated with said master terminal, each one of said terminals assigned to one of said service providers, and
telecommunication means for facilitating exchange of data between said master terminal and said communication terminals, said telecommunication means functionally associated with said master terminal and said communication terminals, said exchange of data comprising a transmission from said master terminal to a communication terminal regarding available service provider, said transmission enabling a service provider to perform a service corresponding to a service request.

2. The system according to claim 1, wherein said service request is a current service request.

3. The management system according to claim 1, wherein said exchange of data further comprises status data transmitted from said communication terminal of the service provider to said master terminal, said status data having been inputted into the communication terminal, and said status data relating to performance status of said service.

4. The management system according to claim 1, wherein said communication terminal further comprises means for inputting status data, said status data relating to future availability of a service provider and said status data being transmitted to said master terminal from said communication terminal, and wherein said availability data comprises said status data.

5. The management system according to claim 3, wherein said communication terminal further comprises means for inputting said status data, said status data relating to future availability of a service provider and said status data being transmitted to said master terminal from said communication terminal, and wherein said availability data comprises said status data.

6. The management system according to claim 1, wherein said telecommunication means further comprises wireless telecommunication means.

7. The management system according to claim 3, wherein said telecommunication means further comprises wireless telecommunication means.

8. The management system according to claim 4, wherein said telecommunication means further comprises wireless telecommunication means.

9. The management system according to claim 1, wherein data is exchanged on an SMS basis.

10. The management system according to claim 3, wherein data is exchanged on an SMS basis.

11. The management system according to claim 4, wherein data is exchanged on an SMS basis.

12. The management system according to claim 1, further comprising a computer functionally associated with said communication means, said computer being programmed to effect said means for storing request data and said means for receiving and storing availability data.

13. The management system according to claim 3, further comprising a computer functionally associated with said communication means, said computer being programmed to effect said means for storing request data and said means for receiving and storing availability data.

14. The management system according to claim 4, further comprising a computer functionally associated with said communication means, said computer being programmed to effect said means for storing request data and said means for receiving and storing availability data.

15. The management system according to claim 1, wherein said mobile communication terminals comprise personal digital assistants with mobile radio communication modems.

16. The management system according to claim 15, wherein said personal digital assistants further comprise scanners.

17. The management system according to claim 3, wherein communication terminals comprise personal digital assistants with mobile radio communication modems.

18. The management system according to claim 17, wherein said personal digital assistants further comprise scanners.

19. The management system according to claim 4, wherein communication terminals comprise personal digital assistants with mobile radio communication modems.

20. The management system according to claim 19, wherein said personal digital assistants further comprise scanners.
